(19) United States
(12) Patent Application Publication
(10) Pub. No.: US 2025/0207229 A1
(43) Pub. Date: Jun. 26, 2025

(54) ELECTRICAL STEELS

(71) Applicant: NUCOR CORPORATION, Charlotte, NC (US)

(72) Inventors: Paul KELLY, Mount Kembla (AU); Yizhou DU, Rolla, MO (US); Mario BUCHELY, Rolla, MO (US); Ronald Joseph O'MALLEY, Rolla, MO (US); Hualong LI, Suzhou, Jiangsu (CN); Yixin SHI, Suzhou, Jiangsu (CN); Aihua CHEN, Suzhou, Jiangsu (CN); Shujuan ZHANG, Suzhou, Jiangsu (CN)

(21) Appl. No.: 18/847,506

(22) PCT Filed: Mar. 17, 2023
(86) PCT No.: PCT/CN2023/082172

§ 371 Date: Sep. 16, 2024

(30) Foreign Application Priority Data
Mar. 18, 2022 (CN) 202210271658.0

(51) Int. Cl. C22C 38/02; C21D 1/74; C21D 6/00; C21D 8/12; C22C 38/00; C22C 38/04; C22C 38/06

(52) U.S. Cl. CPC C22C 38/02; C21D 1/74; C21D 6/008; C21D 8/1211; C21D 8/1222; C21D 8/1272; C22C 38/004; C22C 38/04; C22C 38/06; C21D 2201/05

(57) ABSTRACT

An electrical steel strip that is less than 3 mm in thickness and is made from a molten electrical steel melt having a superheat temperature of at least 30° C. above the liquidus temperature Tliquidus of the melt comprising: by weight, up to 0.015% carbon, between 1.0% and 2.0% manganese, between 2.70% and 3.80% silicon, silicon killed containing less than 0.01% aluminum, and optionally any one or more of up Cu, Cr, Ni, Mo, Ti, Nb, V, Sb, and Sn; and the remainder iron, impurities and inclusions, is disclosed. A twin roll cast and hot rolled electrical steel strip is disclosed. A subsequently cold rolled and annealed electrical steel strip is also disclosed. Methods of producing these products via a twin roll strip caster are also disclosed.

### TECHNICAL FIELD AND BACKGROUND

The invention relates to making thin steel strip in a twin roll caster and in downstream processing steps that is suitable for use in electrical steel applications.

In a twin roll caster, molten metal, typically steel, is delivered from a delivery system to a casting pool supported on casting surfaces of a pair of counter-rotated horizontal casting rolls, which are internally water cooled so that solidified metal shells form on the moving casting roll surfaces. The metal shells are brought together at a nip between them to produce a solidified strip product delivered downwardly from the nip between the casting rolls. The term “nip” is used herein to refer to the general region at which the casting rolls are closest together.

The molten metal may be poured from a ladle into a smaller vessel or series of smaller vessels from which it flows through a metal delivery nozzle or nozzles located above the nip, to form the casting pool of molten metal supported on the casting surfaces of the casting rolls above the nip and extending the length of the nip.

The casting pool is usually confined between side plates or side dams held in sliding engagement with end portions of the casting rolls to restrict the casting pool against outflow. The upper surface of the casting pool (generally referred to as the “meniscus” level) is usually above the lower end of the delivery nozzle so that the lower end of the delivery nozzle is immersed within the casting pool.

When casting steel strip by a twin roll caster, the thin strip exits the nip, passes across a guide table, through a pinch roll stand and then through a hot rolling mill, where the thin strip is reduced to a desired thickness. The hot rolled strip is then cooled to form strip with a required microstructure for end use applications. The cooled strip is then coiled, with a shear cutting the strip periodically upstream of the coiler to form required lengths of strip in each coil.

Depending on the steel compositions and the casting conditions, twin roll cast, hot rolled and cooled strip can be used in a range of end-use applications.

Electrical steels are the focus of the invention.

Electrical steels are low carbon iron-silicon soft magnetic steels which are widely used in electric motors, sensors, power generators, and transformers. Electrical steels can be classified into non-grain-oriented (NGO) and grain-oriented (GO) electrical steels. Cold-rolled non-grain-oriented steel (CRNGO) is generally less expensive than cold-rolled grain-oriented steel (CRGO). Thus, when the cost is important, or when the direction of magnetic flux for an end use application is not constant, NGO electrical steel is used.

When used in an electrical motor, NGO electrical steels are cut to thin laminations that are isolated with insulating coating layers and stacked to form the motor core to decrease eddy current losses. Thus, if thin strip NGO electrical steels can be continuously cast directly to a thin strip, that will be helpful to save the energy and time. The applicant has realized that the twin roll strip casting method has excellent potential because it can directly and continuously cast thin, typically 1-2 mm thick, steel strip.

When NGO electrical steels are cast by a conventional thick slab continuous casting process, it is difficult to maintain the θ-fiber texture which is always formed in a hot rolling step in the process. During subsequent cold rolling and recrystallization annealing steps in the process, strong α-fiber and γ-fiber textures are commonly observed. The formation of deformed matrix shear bands directly influenced the nucleation and growth of Goss grains in the recrystallization annealing process. Furthermore, because of the low local dislocation density and the sharp lattice curvature, the retained Goss grains after cold rolling can also promote the formation of Goss grains in the recrystallization annealing step in the process.

Based on the end use applications, it is important to control the magnetic properties of NGO electrical steels. The magnetic properties of NGO electrical steels are highly influenced by grain size and texture, which are in turn influenced by rolling and recrystallization annealing steps. It has been reported that, after final annealing, 2.0 wt. % Si NGO electrical steel has strong {1 1 0} (0 0 1) (Goss) texture. It has also been reported that, for 4.5 wt. % Si NGO electrical steel, two-step cold rolling can help to form coarse grains with a strong Goss and near Goss recrystallization texture in the annealing process.

As noted in the preceding paragraph, the magnetic properties of electrical steels are highly influenced by texture. In electrical steels, the <001> axis direction is easily magnetized, while the <111> axis direction is more difficult to magnetize. It is known that Goss and Cube orientations optimize magnetic properties. Brass and Goss orientations are reported to be formed in the BCC metals through shear deformation texture. It has also been reported that many Goss grains and Cube grains are formed at the shear bands within the γ-fiber deformed regions. It has also been reported that some Cube components are retained after the heavy cold rolling process because the Cube deformation bands also serve as the nucleation sites of the new Cube grains.

For NGO electrical steels, it is difficult to control texture during recrystallization annealing. It has also been reported that, in some cases, a phase transformation can be used to obtain the ideal orientation for magnetic properties. During annealing, because of anisotropic strain energy, some {100} oriented grains are formed when austenite transforms to ferrite. However, this transformation is not available for fully ferritic steel compositions. Methods to achieve ideal crystallographic orientations with chemical compositions without a phase transformation have also been studied in the literature. The influence of initial annealing on texture evolution and magnetic properties for a 3.4 wt. % Si electrical steel with 0.003 wt. % C has been studied. The recrystallization kinetics of a 3 wt. % Si electrical steel have also been studied.

It has also been reported that the rolling process has a significant influence on texture evolution, grain growth, and magnetic properties. In the recrystallization annealing process, some ideal textures evolve from deformed shear bands which are formed by the rolling process. Furthermore, the phase transformation during hot deformation also affects the recrystallization rate and grain size in the subsequent annealing process. It has also been reported that reported that for a 6.2 wt. % Si electrical steel with less than 0.01 C, hot rolling was beneficial to the final magnetic properties. It has also been reported that the beneficial effects of annealing prior to cold rolling on the electrical steel microstructure and magnetic properties.

Although there have already been some studies conducted that examine the influence of rolling and recrystallization annealing in manufacturing NGO electrical steels, there are few studies about the influence of rolling and annealing on thin electrical steel strip produced by a twin-roll casting method.

The above comments are not an admission of the common general knowledge in China or elsewhere.

### SUMMARY

In broad terms, the invention includes a method and an apparatus for producing an electrical steel strip and a product electrical steel strip. The method includes twin roll strip casting a thin strip of less than 3 mm in thickness from an electrical steel melt having a superheat temperature of at least 30° C. above the liquidus temperature Tliquidus of the melt, hot rolling, cooling and coiling the strip. The melt comprises: by weight, up to 0.015% carbon, between 1.0% and 2.0% manganese, between 2.70% and 3.80% silicon, silicon killed (with no purposeful addition of aluminium) containing less than 0.01% aluminum, and optionally any one or more of Cu, Cr, Ni, Mo, Ti, Nb, V, Sb, Sn, and the remainder iron, impurities and inclusions.

The invention includes a twin roll casting method of producing an electrical steel strip that includes:
casting a continuous thin electrical steel strip of less than 3 mm in thickness in a twin roll caster from an electrical steel melt with a superheat temperature of at least 30° C. above the liquidus temperature Tliquidus of the melt, the melt comprising: by weight, up to 0.015% carbon, between 1.0% and 2.0% manganese, between 2.70% and 3.80% silicon, silicon killed containing less than 0.01% aluminum, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions;
hot rolling the electrical steel strip in a hot rolling mill and reducing the thickness of the strip;
cooling the electrical steel strip in a cooling station and cooling the strip; and
coiling the electrical steel strip in a coiler and forming coils of lengths at the coiler.

The Mn concentration range of between 1.0% and 2.0% manganese makes it possible for the melt to have a low Al concentration (i.e. less than 0.01% aluminum), without an impact on resistivity of the resultant electrical steel strip. The melt is a silicon killed, as opposed to an Al-killed, steel.

The term “impurities” means elements in the melt as an inevitable result of steelmaking practices or as a consequence of the feed materials for steelmaking. These tend to be non-metallic elements. Examples of impurities are N, P, S, and H.

The term “inclusions” means compounds that form during steelmaking. Examples of “inclusions” include AlN and MnS.

The Cu concentration may be less than 0.3%.

The Cr concentration may be less than 0.2%.

The Cr concentration may greater than 0.01%.

The Ni concentration may be less than 0.2%.

The Mo concentration may be less than 0.1%.

The Mo concentration may be less than 0.06%.

The Mo concentration may be greater than 0.001%.

The concentration of Sb may satisfy the formula Sn+2*Sb<0.4%.

The concentration of Sb may be less than 0.2%.

The concentration of Sb may be less than 0.1%.

The Sb concentration may be greater than 0.001%.

The carbon concentration may be up to 0.0060%.

The carbon concentration may be up to 0.0080%.

The carbon concentration may be up to 0.01%.

The manganese concentration may be at least 1.10%.

The manganese concentration may be at least 1.20%.

The manganese concentration may be less than 1.70%.

The manganese concentration may be less than 1.80%.

The manganese concentration may be between 1.10% and 1.55%.

The silicon concentration may be at least 2.80%.

The silicon concentration may be at least 3.00%.

The silicon concentration may be no more than 3.70%.

The silicon concentration may be no more than 3.60%.

The silicon concentration may be no more than 3.50%.

The silicon concentration may be between 2.70% and 3.50%.

The concentrations of C, Mn and Si in the electrical steel melt may be as follows:

TABLE 1
Aim Chemistry for C, Mn, and Si - weight %

| | C | Mn | Si |
|---|---|---|---|
| Max | 0.0060 | 1.55 | 3.45 |
| Aim | 0.0025 | 1.50 | 3.40 |
| Min | | 1.45 | 3.35 |

The concentrations of residuals in the electrical steel melt may be as follows in one embodiment:

TABLE 2
Key residuals and non-metallic elements - one embodiment - weight %

| | S | P | Cr | Mo | Al | Cu | Ni | Nb | Ti | V |
|---|---|---|---|---|---|---|---|---|---|---|
| Max | 0.002 | 0.018 | 0.03 | 0.0020 | 0.002 | 0.03 | 0.03 | 0.0020 | 0.0020 | 0.0020 |
| Typical | 0.0020 | 0.009 | | | | | | | | |

The concentrations of residual gases in the electrical steel melt may be as follows:

TABLE 3
Gases and intermetallic - weight %

| | N | O | H |
|---|---|---|---|
| Max | 0.0090 | | 0.0020 |
| Typical | 0.0050 | | |

The electrical steel in the coiled strip may have an at least substantially ferritic microstructure.

The microstructure of the electrical steel in the coiled strip may be at least substantially equiaxed grains.

The method may include cold rolling the electrical steel strip to further reduce the thickness of the strip.

The method may include cold rolling the electrical steel strip to further reduce the thickness of the strip to be no more than 0.50 mm, typically no more than 0.35 mm.

The method may include pickling the electrical steel strip before the cold rolling step.

The method may include annealing the electrical steel strip to obtain non-grain oriented electrical steel strip with desired magnetic properties.

The desired magnetic properties may be core loss or permeability. These terms are well-understood by persons skilled in the art of electrical steels and are covered by industry standards. Typically, a customer places an order with a steelmaker for an electrical steel having a particular thickness and core loss and/or permeability.

The desired magnetic properties may be as described in Chinese Standard GB/T 2521.1 entitled “Cold-rolled electrical steel delivered in the fully-processed state-Part 1: Grain non-oriented steel strip (sheet)”.

For example, the desired magnetic properties may be as described in the standard as 35W250, 0.35 mm, core loss P1.5/50 of 2.50 Watts/kg of electrical steel.

By way of further example, the desired magnetic properties may be as described in the standard as 35W300, 0.35 mm, core loss P1.5/50 of 3.00 Watts/kg of electrical steel.

The annealing step may be conducted in a controlled atmosphere, such as a mixed gas of hydrogen and nitrogen.

The annealing step may be conducted in a controlled atmosphere that reduces the carbon concentration to be no more than 0.0030%.

The electrical steel melt may be made by any suitable steelmaking method.

By way of example, the electrical steel melt may be made by and then transferred to the twin roll strip caster by the following steps: electric arc steel making furnace (EAF)→ladle furnace→tank or RH degasser→tundish→twin roll strip caster.

Alternatively, the electrical steel melt may be made by and then transferred to a twin roll strip caster by the following steps: basic oxygen steel making furnace (BOF)→ladle furnace→RH degasser→tundish→twin roll strip caster.

The method may include superheating the electrical steel melt to the superheat temperature before transferring the melt to the twin roll caster.

By way of example, the method may include superheating the electrical steel melt to the superheat temperature in any one or more of a steelmaking furnace, a ladle or tundish or other vessel that transfers the electrical steel melt from the steelmaking furnace to the twin roll caster.

By way of particular example, the method may include superheating the electrical steel melt to the superheat temperature in a tundish by means of tundish heating technology.

The method may include preparing the molten electrical steel melt with the superheat temperature.

The method may include delivering the molten electrical steel melt with the superheat temperature to the twin roll caster.

The superheat temperature may be Tliquidus+up to 120° C., i.e. up to 120° C. above the liquidus temperature.

The superheat temperature may be Tliquidus+up to 90° C., i.e. up to 90° C. above the liquidus temperature.

The superheat temperature may be Tliquidus+up to at least 35° C., i.e. at least 35° C.° C. above the liquidus temperature.

The superheat temperature may be Tliquidus+up to at least 40° C., i.e. at least 40° C. above the liquidus temperature.

The method may include controlling the hot rolling step so that there is a hot rolling mill exit temperature of 800-900° C.

The method may include supplying nitrogen to a hot box that encloses the electrical steel strip between the twin roll caster and the hot rolling mill at a rate of greater than 2500 m³/hr so that there is a high N concentration in the hot box, noting that the value of 2500 m³/hr may vary depending on air leakage into the hot box.

The method may include controlling the hot rolling step so that there is a hot rolling mill exit temperature of 720-820° C.

The method may include supplying nitrogen to a hot box that encloses the electrical steel strip between the twin roll caster and the hot rolling mill at a rate of less than 2500 m³/hr so that there is a low N concentration in the hot box, noting that the value of 2500 m³/hr may vary depending on air leakage into the hot box.

The method may include varying the nitrogen flow rate to a hot box that encloses the electrical steel strip between the twin roll caster and the hot rolling mill to control strip temperature, noting that lower N leads to more air leaking into the hot box, with the air oxidizing strip and increasing its emissivity and thus increasing heat loss and reducing strip temperature at a hot rolling mill entry.

The method may include hot rolling the cast strip with the cast strip entering the hot rolling mill at a mill entry temperature of 140-160° C., typically 150° C.° C. higher than the mill exit temperature.

The method may include coiling the hot rolled and cooled electrical steel strip at a coiler entry temperature in a range of 550-720° C.

The invention also provides an apparatus for producing an electrical steel strip, including
a twin roll strip caster for forming a continuous thin electrical steel strip of less than 3 mm in thickness from a molten electrical steel melt with a superheat temperature of at least 30° C. above the liquidus temperature Tliquidus of the melt, the melt comprising: by weight, up to 0.015% carbon, between 1.0% and 2.0% manganese, between 2.70% and 3.80% silicon, silicon killed containing less than 0.01% aluminum, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions;
a hot rolling mill for reducing the thickness of the electrical steel strip;
a cooling station for cooling the electrical steel strip; and
a coiler for forming coils of the selected lengths of the electrical steel strip.

The apparatus may include a cold rolling mill to reduce the thickness of the electrical steel strip.

The apparatus may include an annealing unit for annealing the electrical steel strip to obtain non-grain oriented electrical steel strip with desired magnetic properties.

The electrical steel strip may be produced from the molten electrical steel melt as described above.

The twin roll strip caster may be configured to cast the molten electrical steel melt with a superheat temperature Tliquidus of up to 120° C. above the liquidus temperature.

The twin roll strip caster may be configured to cast the molten electrical steel melt with a superheat temperature Tliquidus of up to 90° C. above the liquidus temperature.

The twin roll strip caster may be configured to cast the molten electrical steel melt with a superheat temperature Tliquidus of at least 35° C. above the liquidus temperature.

The twin roll strip caster may be configured to cast the molten electrical steel melt with a superheat temperature Tliquidus of at least 40° C. above the liquidus temperature.

The invention also provides a twin roll strip cast and hot rolled electrical steel strip of less than 3 mm in thickness comprising a composition of by weight, up to 0.015% carbon, between 1.0% and 2.0% manganese, between 2.70% and 3.80% silicon, silicon killed containing less than 0.01% aluminum, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions.

The concentrations of the residuals may be as described in Table 2.

The electrical steel strip may have a microstructure that is at least substantially a ferritic microstructure.

The microstructure of the electrical steel strip may be at least substantially equiaxed grains.

The Cu concentration may be less than 0.3%.

The Cr concentration may be less than 0.2%.

The Cr concentration may greater than 0.01%.

The Ni concentration may be less than 0.2%.

The Mo concentration may be less than 0.1%.

The Mo concentration may be less than 0.06%.

The Mo concentration may greater than 0.001%.

The concentration of Sb may satisfy the formula Sn+2*Sb<0.4%.

The concentration of Sb may be less than 0.2%.

The concentration of Sb may be less than 0.1%.

The Sb concentration may greater than 0.001%.

The carbon concentration may be up to 0.0060%.

The carbon concentration may be up to 0.0080%.

The carbon concentration may be up to 0.01%.

The manganese concentration may be at least 1.10%.

The manganese concentration may be at least 1.20%.

The manganese concentration may be less than 1.70%.

The manganese concentration may be less than 1.80%.

The manganese concentration may be between 1.10% and 1.55%.

The silicon concentration may be at least 2.80%.

The silicon concentration may be at least 3.00%.

The silicon concentration may be no more than 3.70%.

The silicon concentration may be no more than 3.60%.

The silicon concentration may be no more than 3.50%.

The silicon concentration may be between 2.70% and 3.50%.

The invention also provides a twin roll strip cast, hot rolled, cold rolled and annealed electrical steel strip of less than 3 mm in thickness comprising a composition of by weight, up to 0.015% carbon, between 1.0% and 2.0% manganese, between 2.70% and 3.80% silicon, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions.

The electrical steel strip may have a microstructure that is at least substantially a ferritic microstructure.

The microstructure of the electrical steel strip may be at least substantially equiaxed grains.

The concentrations of carbon, manganese, silicon, and residuals may be as described above, noting that the carbon concentration may be lower than the melt concentration due to de-carburization when the electrical steel strip is annealed.

The electrical steel strip may have desired magnetic properties.

The desired magnetic properties may be as described in Chinese Standard GB/T 2521.1-2016 entitled “Cold-rolled electrical steel delivered in the fully-processed state-Part 1: Grain non-oriented steel strip (sheet)”.

For example, the desired magnetic properties may be 35W250 0.35 mm Core loss P1.5/50-2.50 Wkg-1 or 35W300 0.35 mm Core loss P1.5/50-3.00 Wkg-1.

It is noted that, whilst there may be 100% ferrite in the microstructures of (a) twin roll strip cast and hot rolled electrical steel strip and (b) twin roll strip cast and hot/cold rolled and annealed electrical steel strip, the invention extends to situations whether this is not the case and, for example, there is some austenite in the microstructure.

It is also noted that the microstructure will be a function of a range of factors, including composition, superheat, and selections of casting, hot rolling, cold rolling and annealing conditions.

### BRIEF DESCRIPTION OF THE DRAWINGS

In order that the invention may be described in more detail, some illustrative examples will be given with reference to the accompanying drawings in which:

FIG. 1 is a diagrammatical side view of an embodiment of a twin roll caster of the invention;

FIG. 2 is an enlarged partial sectional view of a portion of the twin roll caster of FIG. 1;

FIG. 3 is a partial diagrammatical side view of the exit end of the twin roll caster of FIG. 1;

FIG. 4(a) shows a schematic diagram of a sampler used in a vacuum assisted (VA) fast cooling method to produce samples in experimental work;

FIG. 4(b) shows an as-cast sample after solidification in the VA sampler;

FIG. 5 is a schematic diagram of a thermo-mechanical processing route used in the experimental work;

FIG. 6 is a dendrite structure of a VA as-cast sample;

FIG. 7(a) is an image that shows the structure of a processed sample that was not hot rolled (HR);

FIG. 7(b) are images that show the structures of 25% HR and 47% HR samples;

FIG. 8(a) is a graph of average grain sizes versus annealing time for high C and S samples with 0%, 25% and 47% HR after 1, 6, 18, 24 hrs batch annealing at 1050° C.;

FIG. 8(b) is a graph of average grain sizes versus annealing time for low C and S samples with 0%, 25% and 47% HR after 1, 6, 18, 24 hrs batch annealing at 1050° C.;

FIG. 9 is a graph that shows the precipitates size distribution of a VA sample before and after final annealing;

FIG. 10 shows the typical textures in Orientation Distribution Function (“ODF”) sections of fully processed electrical steel samples reported in the literature;

FIG. 11 is an ODF map displayed at φ2=0° section of the final annealed high C and S strip sample with (a) 0% HR, (b) 25% HR, (c) 47% HR, and ODF map displayed at φ2=45° section with (d) 0% HR, (e) 25% HR, (f) 47% HR;

FIG. 12 is an ODF map displayed at φ2=0° section of the final annealed low C and S strip sample with (a) 0% HR, (b) 25% HR, (c) 47% HR, and ODF map displayed at φ2=45° section with (d) 0% HR, (e) 25% HR, (f) 47% HR;

FIGS. 13 to 18 are a series of further ODF maps displayed at φ2=0° and 45° Sections for VA samples that were batch annealed at 1050° C. for 1, 6, and 24 hrs;

FIG. 19 is a series of graphs of volume fractions of the main textures versus annealing time for the high C and S VA samples with (a) 0% HR, (b) 25% HR, (c) 47% HR, and the low C and S VA samples with (d) 0% HR, (e) 25% HR, (f) 47% HR; and

FIG. 20 is a graph that provides a comparison between predicted value and measured result on core loss P_{1.5/50}.

### DETAILED DESCRIPTION OF THE DRAWINGS

The following description of embodiments of electrical steel strip produced by a twin roll strip casting method are not the only embodiments of the invention.

In addition, the following description of an embodiment of a twin roll caster is not the only embodiment of a twin roll caster suitable to produce electrical steel strip in accordance with the invention.

All other embodiments obtained by the ordinary person skilled in this art based on the described embodiments of the invention without any creative endeavors fall into the protection scope of the invention.

Unless defined otherwise, the technical terms or scientific terminology as used in the present disclosure should take the meaning usually understood by the ordinary person skilled in this art of invention.

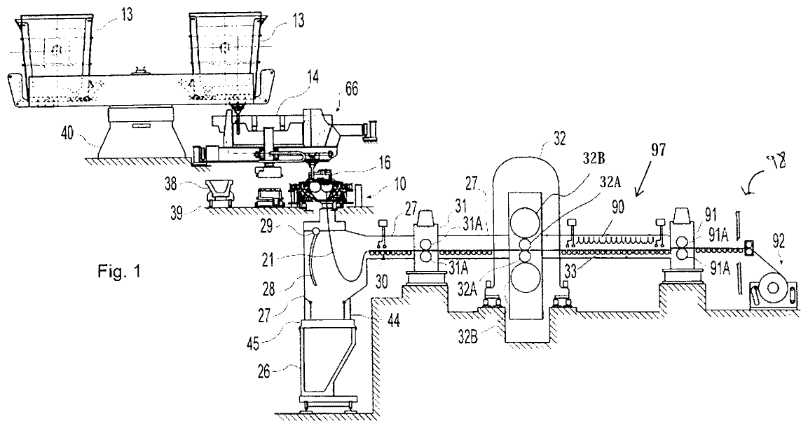

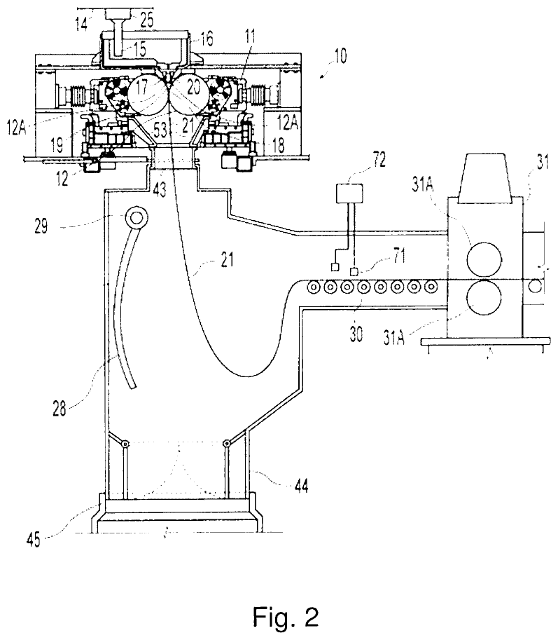

Referring now to FIGS. 1 and 2, a twin roll caster is illustrated that comprises a main machine frame 10 that stands up from the factory floor and supports a pair of counter-rotatable casting rolls 12 mounted in a module in a roll cassette 11. The casting rolls 12 are mounted in the roll cassette 11 for ease of operation and movement as described below. The roll cassette 11 facilitates rapid movement of the casting rolls 12 ready for casting from a setup position into an operative casting position as a unit in the caster, and ready removal of the casting rolls 12 from the casting position when the casting rolls 12 are to be replaced. There is no particular configuration of the roll cassette 11 that is desired, so long as it performs that function of facilitating movement and positioning of the casting rolls 12 as described herein.

The twin roll caster includes the pair of counter-rotatable casting rolls 12 having casting surfaces 12A laterally positioned to form a nip 18 there between. Molten metal, more particularly molten electrical steel described further below, is supplied from a ladle 13 through a metal delivery system to a metal delivery nozzle 17 (core nozzle) positioned between the casting rolls 12 above the nip 18. Molten metal thus delivered forms a casting pool 19 of molten metal above the nip 18 supported on the casting surfaces 12A of the casting rolls 12. This casting pool 19 is confined in the casting area at the ends of the casting rolls 12 by a pair of side closure plates, or side dams 20. The upper surface of the casting pool 19 (generally referred to as the “meniscus” level) may rise above the lower end of the delivery nozzle 17 so that the lower end of the delivery nozzle 17 is immersed within the casting pool 19. The casting area includes the addition of a protective atmosphere above the casting pool 19 to inhibit oxidation of the molten metal in the casting area.

The ladle 13 typically is of a conventional construction supported on a rotating turret 40. For metal delivery, the ladle 13 is positioned over a movable tundish 14 in the casting position to fill the tundish 14 with molten metal. The movable tundish 14 may be positioned on a tundish car 66 capable of transferring the tundish 14 from a heating station (not shown), where the tundish 14 is heated to near a casting temperature, to the casting position.

The movable tundish 14 may be fitted with a slide gate 25, actuable by a servo mechanism, to allow molten metal to flow from the tundish 14 through the slide gate 25, and then through a refractory outlet shroud 15 to a transition piece or distributor 16 in the casting position. From the distributor 16, the molten metal flows to the delivery nozzle 17 positioned between the casting rolls 12 above the nip 18.

The side dams 20 may be made from a refractory material such as zirconia graphite, graphite alumina, boron nitride, boron nitride-zirconia, or other suitable composites. The side dams 20 have a face surface capable of physical contact with the casting rolls 12 and molten metal in the casting pool 19. The side dams 20 are mounted in side dam holders (not shown), which are movable by side dam actuators (not shown), such as a hydraulic or pneumatic cylinder, servo mechanism, or other actuator to bring the side dams 20 into engagement with the ends of the casting rolls 12. Additionally, the side dam actuators are capable of positioning the side dams 20 during casting. The side dams 20 form end closures for the molten pool of metal on the casting rolls 12 during the casting operation.

FIG. 1 shows the twin roll caster producing the cast thin strip 21, with the cast strip moving initially downwardly and then looping upwardly to a guide table 30 through a hot box that contains a controlled, protective atmosphere, for example containing nitrogen, to minimize strop oxidation, and move across a guide table 30 to a pinch roll stand 31, comprising pinch rolls 31A. Upon exiting the pinch roll stand 31, the cast thin strip 21 may pass through a hot rolling mill 32, comprising a pair of work rolls 32A, and backup rolls 32B, forming a gap capable of hot rolling the cast thin strip 21 delivered from the casting rolls 12, where the cast thin strip 21 is hot rolled to reduce the strip to a desired thickness, improve the strip surface, and improve the strip flatness. The work rolls 32A have work surfaces relating to the desired strip profile across the work rolls 32A. The hot rolled cast thin strip 21 then passes onto a run-out table 33 within cooling station 97, where it may be cooled by contact with a coolant, such as water, supplied via spray nozzles 90 or other suitable means, and by convection and radiation. In any event, the cooled hot rolled cast thin strip 21 passes through a second pinch roll stand 91 having a pair of rollers 91A that provide tension to the cast thin strip 21. Finally, the cooled hot rolled cast thin strip 21 is then coiled, with a shear at a shear station 98 cutting the strip periodically upstream of the coiler to form required length of strip for each coil.

The casting rolls 12 are internally water cooled as described below so that as the casting rolls 12 are counter-rotated, shells solidify on the casting surfaces 12A, as the casting surfaces 12A move into contact with and through the casting pool 19 with each revolution of the casting rolls 12. The shells are brought close together at the nip 18 between the casting rolls 12 to produce a cast thin strip product 21 delivered downwardly from the nip 18. The cast thin strip product 21 is formed from the shells at the nip 18 between the casting rolls 12 and delivered downwardly and moved downstream as described above.

In operation, the strip leaves the nip at temperatures of the order of 1400° C. and greater. To prevent oxidation and scaling of the strip, the metal strip is cast downwardly into the enclosure 27 supporting a protective atmosphere immediately beneath the casting rolls in the casting position. The enclosure 27 may extend along the path of the cast thin strip until the first pinch roll stand 31 and may extend along the path of the cast thin strip until the hot rolling mill 32 to reduce oxidation and scaling.

After the hot rolling mill 32, the rolled thin strip then passes into a cooling station 97 where the strip is cooled by water that is delivered by spray nozzles 90 of a plurality of rows of water spray assemblies extending across the run-out table 33 as the strip moves over the run-out table 33 in the cooling station 97. While spray nozzles atomize coolant to generate a spray, any other coolant discharge port may be employed in any embodiment in lieu of spray nozzles. In addition to generating a spray, other types of coolant discharge ports may discharge a non-atomized flow of coolant.

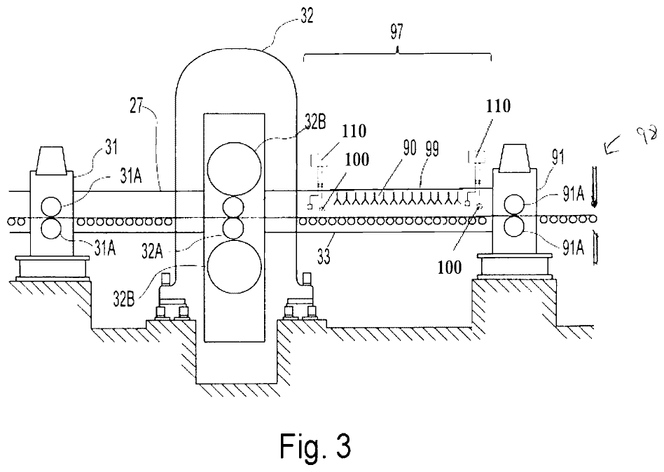

In the exemplary embodiment shown in FIG. 3, cooling station 97 extends along the path 99 of the strip between the hot rolling mill 32 and the second pinch roll stand 91 with multiple spray nozzles 90 in the multiple rows of water spray assemblies arranged there between. Although it is not discernable in the view depicted in FIG. 3, the rows of spray nozzles 90 extend substantially across the strip width or the cooling station width in a widthwise arrangement and are spaced apart along the length of the cooling station.

Finally, the cooled, hot rolled strip is coiled.

Further details of the twin roll caster described in relation to FIGS. 1-3 can be found in the specification of Chinese Patent Application No. 201780029304.2 in the name of the applicant and the disclosure in that specification is incorporated herein by cross-reference.

The above-described embodiments of a twin roll caster and method are suitable for producing electrical steel strip less than 3 mm in thickness from a molten electrical steel melt with a superheat temperature of at least 30° C. above the liquidus temperature Tliquidus of the melt and up to a superheat temperature of Tliquidus+up to 120° C., with the melt comprising: by weight, up to 0.015% carbon, typically up to 0.0060% carbon, between 1.0% and 2.0% manganese, typically between 1.1% and 1.55% manganese, between 2.70% and 3.80% silicon, silicon killed containing less than 0.01% aluminum, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions.

In this context, whilst not described above, there is a range of options for preparing the molten electrical steel melt with the superheat temperature and for delivering the superheated molten electrical steel melt to the twin roll caster that are known to a steelmaker and need not be described further here in detail. By way of example, the options include superheating the electrical steel melt to the superheat temperature in any one or more of a steelmaking furnace, a ladle or tundish or other vessel that transfers the electrical steel melt from the steelmaking furnace to the twin roll caster. One particular option is to superheat the electrical steel melt to the superheat temperature in the tundish 14 using tundish heating technology.

Typically, the hot rolling conditions are selected so that the cast strip leaves the hot rolling mill at a mill exit temperature of 800-900° C. in situations where there is a high N concentration in the hot box and at a mill exit temperature of 720-820° C. in situations where there is a low N concentration in the hot box. Typically, the mill entry temperature is selected to be 140-160° C.° C. higher than the mill exit temperature.

Typically, the cooled hot rolled cast strip is coiled at a coiler entry temperature in a range of 550 to 720° C.

In accordance with embodiments of the invention, the electrical steel strip can be optionally cold rolled to further reduce the thickness of the strip.

In accordance with embodiments of the invention, the cold rolled electrical steel strip can be annealed to develop the desired magnetic properties of the resultant non-grain oriented electrical steel strip.

Typically, the annealing step is conducted in a controlled atmosphere, such as a mixed gas of hydrogen and nitrogen.

Typically, the desired magnetic properties are as described in Chinese Standard GB/T 2521.1-2016 entitled “Cold-rolled electrical steel delivered in the fully-processed state-Part 1: Grain non-oriented steel strip (sheet)”. For example, the desired magnetic properties may be 35W250 0.35 mm Core loss P1.5/50-2.50 Wkg-1 or 35W300 0.35 mm Core loss P1.5/50-3.00 Wkg-1.

It is noted that it is often the case that there is a target C concentration for the steel in end use products. For example, for motors the target C concentration is 0.003%. The levers for obtaining a target concentration in end use products are (1) the C concentration in a steel melt and (2) the annealing step—to decarburize steel.

The applicant, via an external research organization, has carried out the experimental work summarized below to investigate hot rolling and annealing conditions for the invention.

### Experimental Work

In the experimental work, Fe-3.4 wt. % Si non-oriented electrical steel was produced using a vacuum assisted fast cooling sampling method to simulate the solidification conditions of the thin strip twin-roll casting process. The influence of rolling deformation on the magnetic properties, grain growth, and texture were analyzed.

### Materials and Methods

### Materials

Two non-oriented electrical steels with different carbon and sulfur contents were melted in a coreless medium frequency induction furnace under an Argon protective atmosphere.

Table 4 shows the chemical composition of these steels.

TABLE 4
Chemical composition of the studied 3.4 wt. % Si steels (wt. %).

| Steels | C | Si | Mn | Al | S | P | Cr | N |
|---|---|---|---|---|---|---|---|---|
| 1. High | 0.0098 | 3.44 | 1.48 | 0.002 | 0.0087 | 0.010 | 0.028 | 0.0074 |
| C and S | | | | | | | | |
| 2. Low | 0.0046 | 3.45 | 1.50 | 0.001 | 0.0038 | 0.008 | 0.030 | 0.0044 |
| C and S | | | | | | | | |

Steel 1 was produced using a high carbon and sulfur (C and S) composition, while Steel 2 was produced using a low C and S chemistry to avoid the negative influences of precipitates and phase transformations on NGO Si steel magnetic properties. To control the influence of MnS precipitates and the α to γ phase transformation during annealing, a low C and S chemical composition is commonly employed in industry for industrial NGO electrical steel production.

Charges of Steels 1 and 2 were melted in a 90 kg. coreless medium frequency induction furnace with an Ar protective atmosphere.

Samples were directly taken from the induction furnace at 100° C. superheat using a vacuum sampler, described below.

### Sampling Method

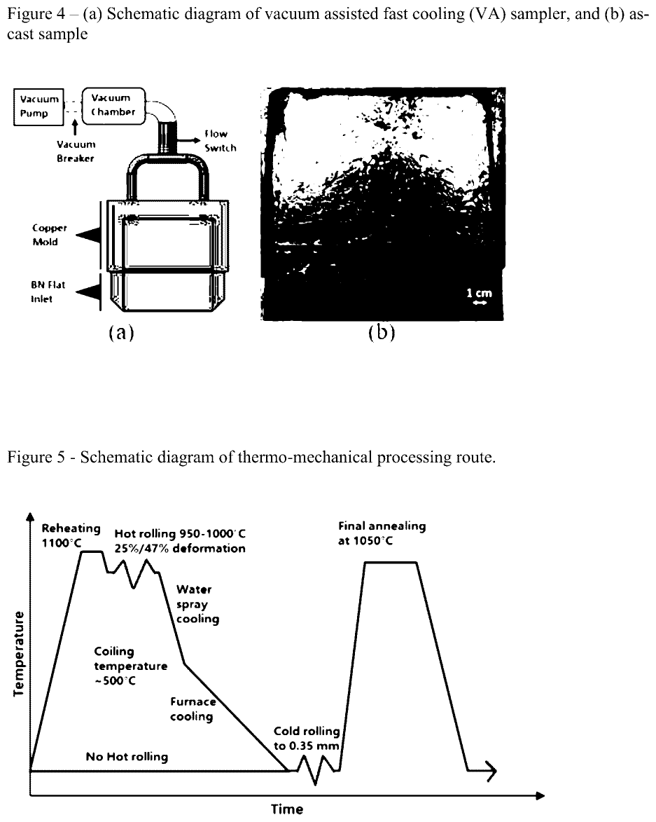

A vacuum assisted fast cooling (VA) sampling method was used to take samples that simulate the solidification conditions of an industrial twin-roll casting process. Specifically, a vacuum assisted process was used to draw liquid steel into a thin internal cavity inside a copper mold to produce a strip sample with high solidification cooling rate. The as-cast samples were 2 mm thick. FIG. 4(a) shows a schematic diagram of the VA sampler, and FIG. 4(b) shows an as-cast sample after solidification in the VA sampler. As reported in previous studies, this method can take uniform 2 mm thick strip sample with proper dendrite structure and calculated solidification cooling rate (˜1700K/s), which properly simulates the solidification conditions of the twin roll strip casting process.

### Processing Schedules

As-cast 2 mm thick samples were thermo-mechanical treated, simulating an embodiment of an industrial thin strip twin-roll casting process. Three thermo-mechanical processing routes were designed. One processing route included hot rolling with different hot rolling (HR) deformations (25% and 47%) at hot rolling temperatures in a range of 950-1000° C.° C. After hot rolling to deformations of 25% and 47%, the samples were cooled to ambient temperature via initial water spray and then furnace cooling and cold rolled to a final thickness of 0.35 mm. The other process route included cold rolling only-no hot rolling step. Higher HR deformation resulted in lower CR deformation with a combined total HR+CR reduction from 2 mm to 0.35 mm thickness. After the rolling process, samples were batch annealed at 1050° C. for various times (1, 6, 18, 24 hrs). A schematic diagram of the above-described thermo-mechanical processing route is shown in FIG. 5.

### Experimental Procedures

Grain size, precipitates size distribution, magnetic properties, and texture distribution of samples with different annealing time were analyzed. The linear intercept method from ASTM E112-13 was used to measure the average grain size, a single sheet tester was used to measure the magnetic properties, automated feature analysis (AFA) on ASPEX PICA 1020 SEM was used in precipitate analysis, and electron backscatter diffraction (EBSD) analysis on Helios SEM equipment was used in analyzing texture distribution. Test samples for magnetic properties were cut along the rolling direction by 100×30 mm size. EBSD analyses were scanned along the RD-ND cross section (Rolling direction-Normal direction planes). The harmonic series expansion method was used in the orientation distribution function (ODF) calculations.

### Microstructure Characterization and Magnetic Properties Test

Samples were prepared metallographically, etched using water-based picric acid to reveal the dendrite structure and Nital etchant to reveal the grain structure. As noted above, the linear intercept method according to ASTM E112-13 was used for performing the secondary dendrite arm spacing (SDAS) and grain size measurement.

The solidification cooling rate of the VA as-cast samples was calculated from the measured SDAS. Based on the expected cooling rate and the chemical composition, the Suzuki's equation was used for this calculation in each case.

$${S}_{2} = 688 ( 60 \times {r}^{) - 0.36} \qquad ( 1 )$$

where S₂ is the SDAS in μm, and r is the solidification cooling rate in K/s.

The optimum grain sizes were used to minimize the core losses for different test conditions. This was because it has been reported that exceptionally coarse grain sizes can lead to higher permeability, lower coercivity, and large domain size, which in turn can increase the core loss. It has been reported that the optimum grain size (GsOp) can be described as follows:

$${G}_{s O p} = ( c ρ / {( {B}^{0.4} {t}^{2} {f}^{〈 1 / 2 )} )}^{2 / 3} \qquad ( 2 )$$

where c is an experimentally determined constant, p is the resistivity, B is the magnetic induction, t is the sample thickness, and f is the operating frequency.

Magnetic properties were measured using a single sheet tester, which was based on the ASTM A1036. The test samples were prepared by cutting processed material into 100 mm long, 30 mm wide strips in the rolling direction. Core loss was measured at 50 and 60 Hz, 1.5 and 1.0 T conditions (P_{1.5/50}, P_{1.5/60}, P_{1.0/50}, P_{1.0/60}). Magnetic induction was measured at 2500 and 5000 A/m conditions (B₂₅, B₅₀). The final recrystallized crystal orientations were analyzed using electron backscatter diffraction (EBSD) in a Helios SEM (30 kV, 11 nA). Scans were conducted on the RD-ND (rolling direction-normal direction planes) cross section. The harmonic series expansion method was used in the orientation distribution function (ODFs) calculations.

### Results and Discussion

### Solidification Cooling Rate

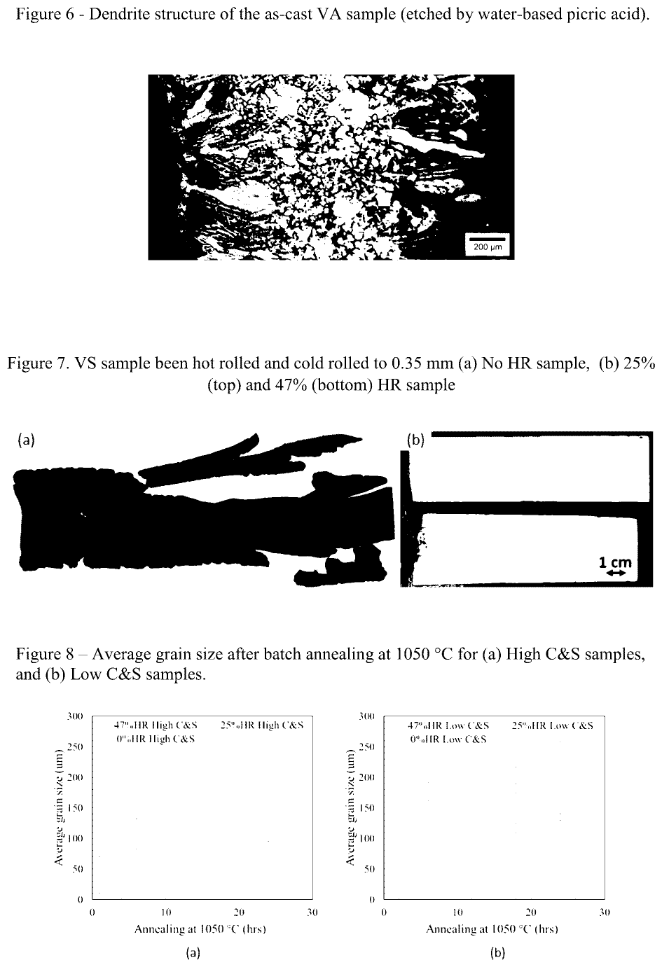

The dendrite structure of a VA as-cast sample is shown in FIG. 6. Using the linear intercept method, the SDAS was measured to be ˜10 μm. Using Eq. (1), the solidification cooling rate was calculated to be ˜1700 K/s, which is in the range reported in industry for 2 mm thick strip direct twin-roll casting method.

The structure of a 0% HR (100% CR) processed sample is shown in FIG. 7(a). As observed, many undesirable edge cracks propagated after the cold rolling process. This was caused by the residual stresses and microstructure of the steel, which formed based on the high solidification cooling rate. On the other hand, little to no edge cracking was observed during the processing of the 25% HR and 47% HR samples, as shown in FIG. 7(b).

### Grain Size Effect

To minimize the core loss of 0.35 mm thick 3.4 wt. % Si NGO electrical steel samples (4.70×10-7 Ω·m) at 1.5 T and 50 Hz condition, Eq. (2) was used to calculate the optimum grain size, which was determined to be ˜ 250 μm for the testing conditions. Thus, steel with a grain size close to 250 μm was expected to exhibit a decreased core loss at the 1.5 T and 50 Hz conditions.

The average grain sizes after 1, 6, 18, 24 hrs batch annealing at 1050° C. are shown in FIG. 8. For the high C and S samples with 24 hrs annealing, with the increase of the HR deformation, the average grain size increased to 89, 148, and 190 μm. For low C and S samples with 24 hrs annealing, with the increase of the HR deformation, the average grain size increased to 136, 199, 249 μm. The measured average grain sizes were all smaller than the calculated optimum grain size. Among samples at the same HR deformation, the samples with lower C and S level showed coarser average grain sizes at each of the measured annealing times. Among the samples with similar C and S level, the samples with higher HR deformation showed coarser average grain sizes at each of the measured annealing time (Sample 47% HR greater than Sample 25% HR greater than Sample 0% HR). The growth rates were higher in the first 6 hrs of batch annealing and slowed in the 6-24 hrs time range. This phenomenon was observed in every sample under each condition.

For samples with high C and S concentrations, the final grain size was influenced by the α to γ phase transformation during the annealing process which likely retarded grain boundary migration.

As reported in a previous study, MnS and different types of oxides are the main precipitates founded in these NGO electrical steels strip samples. The recrystallization and grain growth in annealing process can be inhibited by the pinning effect of these precipitates on the grain boundaries.

It has been reported that the pinning force by small precipitates is as follows:

$${Z}_{p} = \frac{3 {γ}_{GB} {F}_{v}}{2 r} \qquad ( 3 )$$

where γ_{GB} is the grain boundary energy, Fᵥ is the precipitates volume fraction, and r is the precipitate average radius.

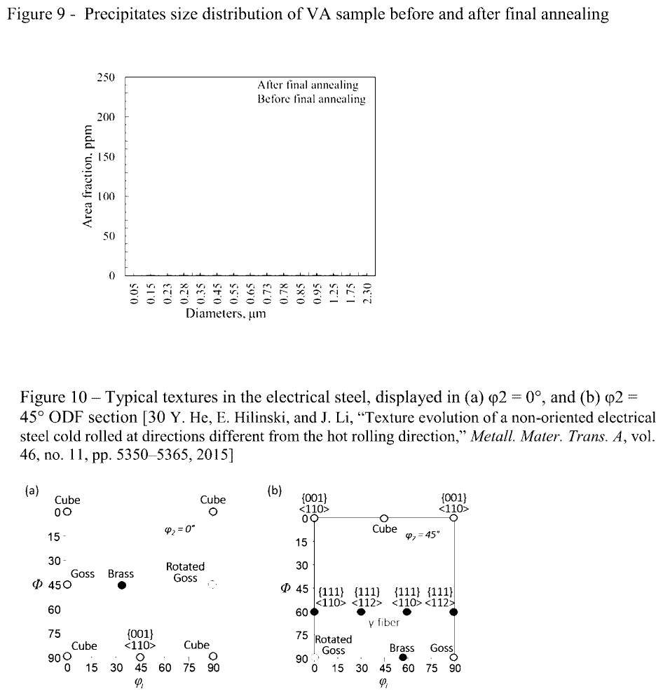

Initially, the pinning force is higher than the driving force for recrystallization and grain growth, Then, as shown in FIG. 9, precipitates coarsen during the annealing process, which gives fewer small precipitates (less than 0.85 μm) and more large precipitates (greater than 0.85 μm) after final annealing.

According to Equation (1), the larger precipitates have a lower the pinning force, which reduces the grain boundary pinning effect.

### Magnetic Properties

The magnetic properties of different HR deformations and 1050° C. for 24 hrs batch annealed samples are shown in Table 5.

TABLE 5
Magnetic properties after final annealing

| | P_{1.5/50} | P_{1.5/60} | P_{1.0/50} | P_{1.0/60} | B₂₅ | B₅₀ | Average grain size |
|---|---|---|---|---|---|---|---|
| | (W/kg) | | (W/kg) | | mT | | μm |
| High C&S (0% HR) | 2.900 | 3.670 | 1.379 | 1.733 | 1672 | 1782 | 89.8 |
| High C&S (25% HR) | 2.380 | 3.047 | 1.176 | 1.491 | 1860 | 1999 | 148.4 |
| High C&S (47% HR) | 2.267 | 2.870 | 1.080 | 1.360 | 1970 | 2096 | 190.0 |
| Low C&S (0% HR) | 2.790 | 3.520 | 1.350 | 1.690 | 1786 | 1924 | 136.4 |
| Low C&S (25% HR) | 2.380 | 3.051 | 1.133 | 1.449 | 1910 | 2079 | 199.4 |
| Low C&S (47% HR) | 2.020 | 2.586 | 0.953 | 1.220 | 1990 | 2109 | 249.2 |

For all chemistries, the 25% HR and 47% HR samples met the magnetic properties requirement for the 35W250 NGO electrical steel at GB/T 2521.1, which is 2.50 W/kg for P_{1.5/50}.

In general, samples processed at higher HR deformations (with same chemical composition), and the samples with lower C and S level (with the same HR deformations) showed better magnetic properties. The results are directly related to the average grain size that was discussed previously. Comparing the magnetic property results from Table 5 and the average grain size results from FIG. 9, magnetic properties improved with the increase of average grain size. The only exception was the samples with 25% HR. Although the low C and S sample had a coarser average grain size than the sample with high C and S, they showed similar core losses at the 1.5 T test condition.

Based on the inclusion analysis reported in a previous study, VA samples all had a similar inclusion size distribution. Thus, other than the grain size differences that were discussed previously, the magnetic properties were also influenced by texture, which will be discussed in the following subsection.

### Texture Effect

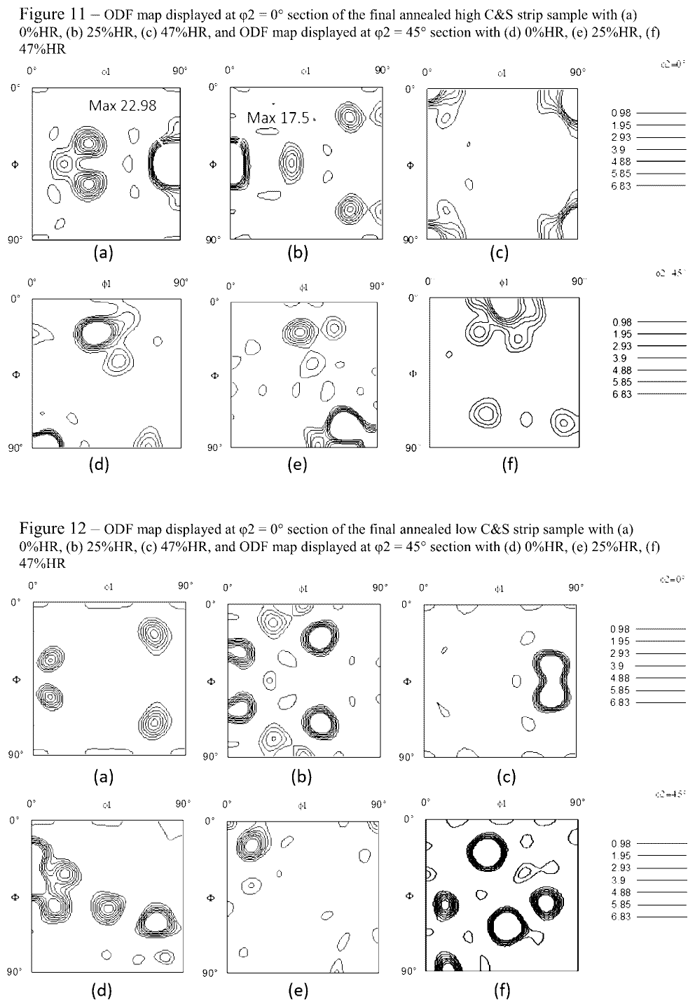

FIG. 10 shows the typical textures expected in the Orientation Distribution Function (“ODF”) section of fully processed electrical steel samples reported in the literature, while FIGS. 11 and 12 show the evolutionary texture intensities and patterns influenced by the rolling process for several samples. The Cube {100} (001), Brass {110} (112), Goss {110} (001) are the main orientations obtained in these ODF images results.

For the high C and S samples, increasing the HR deformation showed a decrease in the intensities of Goss orientation. There were high intensities of Cube orientation on the sample with 47% HR, while there was less on the sample with 25% HR and 0% HR. The γ-fiber had disappeared in each of the samples after annealing, which is beneficial to the magnetic properties. Compared to γ-fiber texture, the Cube and Goss textures were more ideal for magnetic properties.

For the low C and S samples, a rotated Goss orientation was observed in each of the samples. On the sample with 0% HR, there were low intensity Cube orientations and some rotated Goss orientations. This 0% HR sample was highly influenced by the presence of γ-fiber formed during the cold rolling process, while it was absent in the samples with 25% HR and 47% HR.

The recrystallization textures after final annealing were highly influenced by the deformation structure and texture during the rolling process. The strain induced boundary migration (SIBM) and subgrain growth at grain boundaries are considered to be the principal mechanisms for grain nucleation. The subgrain growth is usually observed in <111>//ND (γ-fiber) deformed grain, while the nucleation by SIBM always happens in <100>//ND (θ-fiber) deformed grain. With HR prior CR processing, the proportion of γ-fiber shear bands was decreased while the retention of {100} deformation microstructure was enhanced. Widespread shear bands within the γ-fiber deformed regions provided large number of new Goss grains.

Among samples at 25% HR deformation, the sample with high C and S showed a higher intensity of Goss orientations, while the intensity of the Cube texture was lower on the sample with low C and S. This appears to explain why at 25% HR deformation, despite the fact that the grain size of low C and S sample was coarser, it had similar core loss results compared to the high C and S sample at 1.5 T condition.

### Texture Evolution Texture Components

In FIGS. 11 to 18, ODF images are displayed at +2=0° and 45° sections for samples that were batch annealed at 1050° C. for 1, 6, 24 hrs.

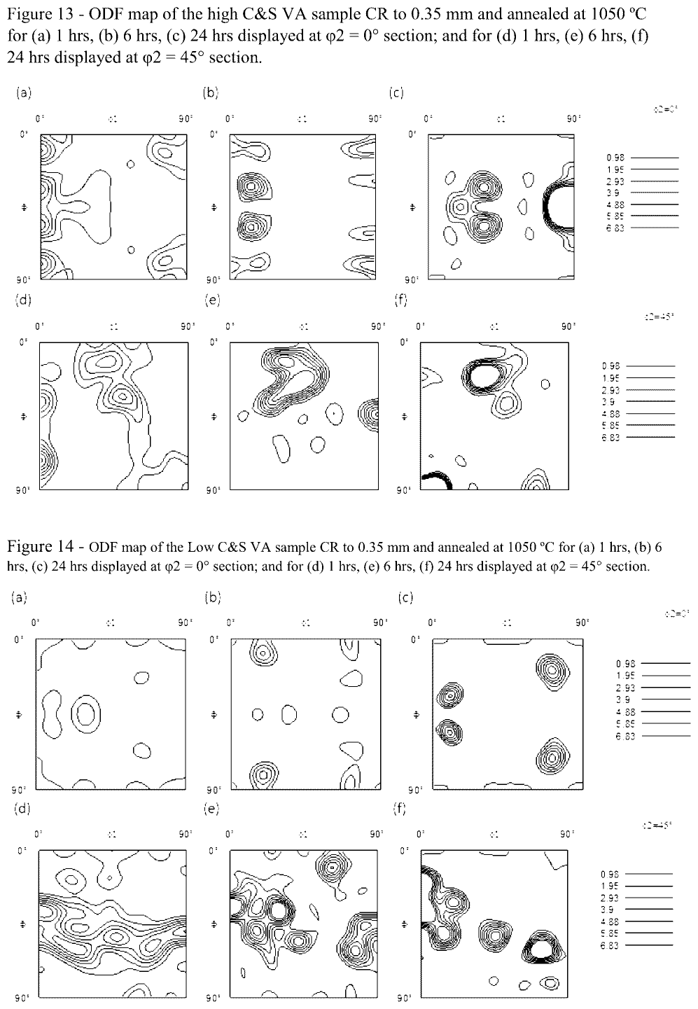

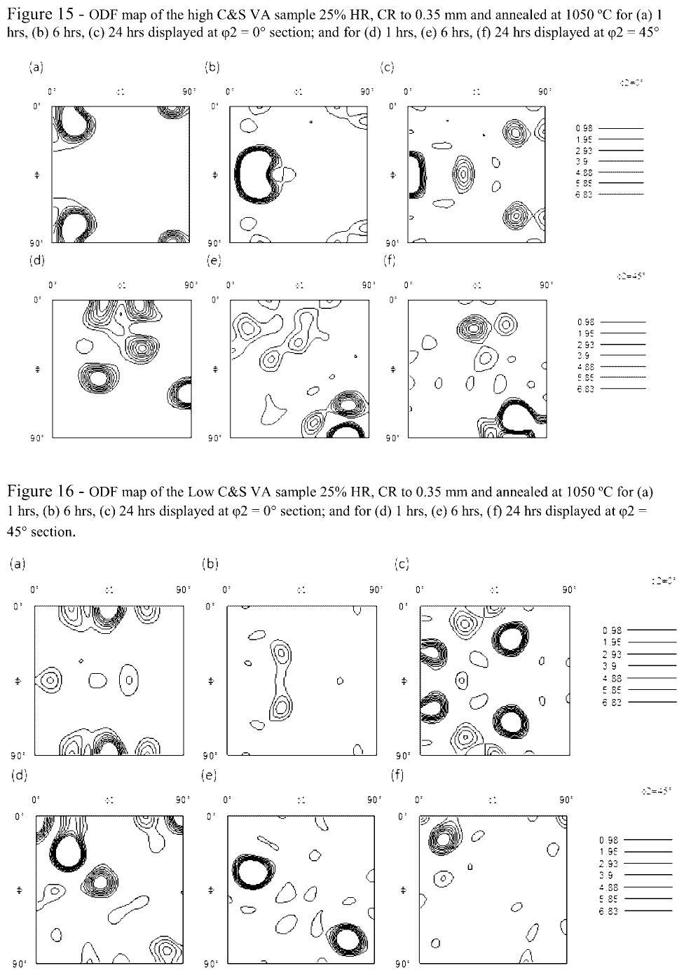

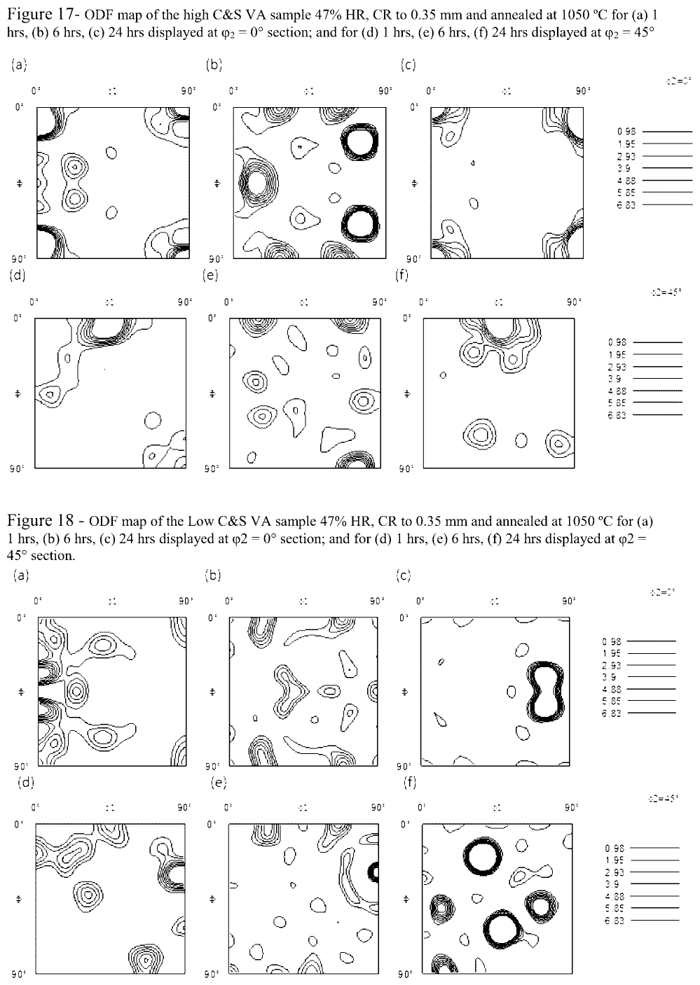

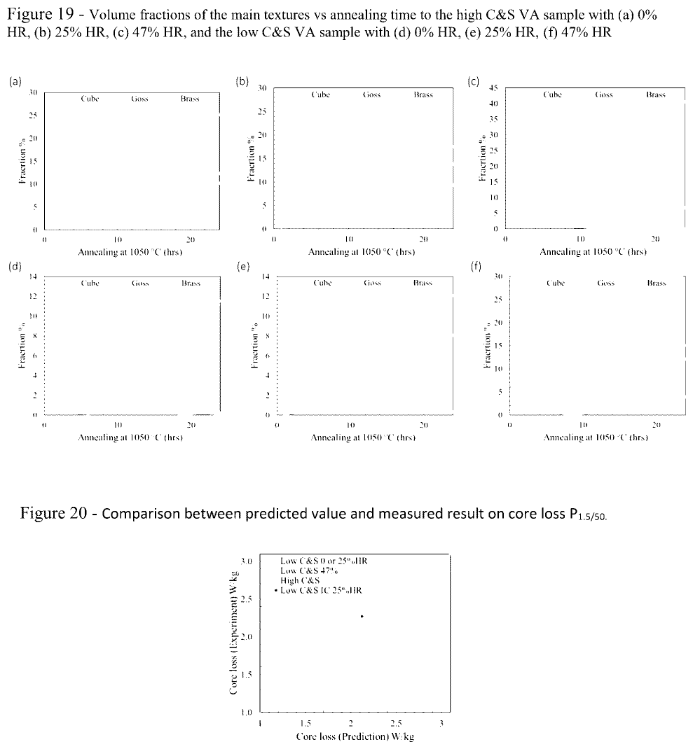

FIGS. 13, 15, and 17 show ODF images of the high C and S steel, while FIGS. 14, 16, and 18 show ODF images for low C and S steel. In addition, FIGS. 14 and 15 show ODF images for the 0% HR samples, FIGS. 15 and 16 show ODF images for the 25% HR samples, and FIGS. 17 and 18 show ODF images for the 47% HR samples. The variations of the main texture volume fractions as a function of annealing time are shown in FIG. 19.

For the high C and S 0% HR samples (FIG. 13), non-uniform α-fiber (<110>//rolling direction [RD]) and α*-fiber ({hhl}<h/l+1 h/l+2 h/l>) textures can be observed after 1 hr of annealing. After 6 hrs of annealing, non-uniform α*-fiber texture could still be observed, while the α-fiber texture had already disappeared. After 24 hrs annealing, the α*-fiber texture had also disappeared.

As a comparison, the low C and S 0% HR samples (FIG. 14) were highly influenced by the γ-fiber ((111)//ND) texture formed before the annealing process. High intensity γ-fiber texture and weak non-uniform α*-fiber texture were observed after 1 hr of annealing. After 6 hrs of annealing, high intensity γ-fiber texture could still be observed, but it becomes non-uniform. After 24 hrs, the high intensity γ-fiber texture became more non-uniform. The non-uniform α*-fiber texture could be observed after 6 and 24 hrs.

This phenomenon can be explained by fiber texture evolution. The 0% HR samples were highly influenced by the α*-fiber and γ-fiber textures which formed before the annealing process. The formation of α*-fiber and γ-fiber textures are related to the high CR deformation and strain for the 0% HR sample. In the CR process, with the increase of deformation and strain, rotated Goss orientation will gradually rotate to {111}<110> orientation, and then form the γ-fiber texture. Finally, with the further increase of deformation and strain, α-fiber and α*-fiber textures will appear.

The main texture volume fraction of the 0% HR samples (FIGS. 19(a) and 19(d)), mostly decreased between 1 to 6 hrs of annealing time. Between 6 to 24 hrs, the volume fraction of the Goss orientation increased significantly, while the fractions of other main orientations remained largely unchanged. The main difference was that, compared to the low C and S sample, the high C and S sample Brass orientation volume fraction also increased between 6 to 24 hrs.

Theories in the literature for the thermodynamic driving force for grain growth and critical radius are helpful in explaining the texture evolution. Critical radius can be described as follows:

$${R}_{c} = - \frac{2 γ}{Δ {G}_{v}} \qquad ( 4 )$$

where γ is the boundary energy, and ΔGᵥ is the driving force.
the velocity of grain boundary can be described as follows:

$$v = M γ \frac{2}{R} \qquad ( 5 )$$

where γ is the boundary energy, R is radius, and M is grain boundary mobility (which depends on orientation of adjacent grains).

The texture evolution in FIGS. 13 and 14 can be divided into two steps.

In the first step, the decrease in the volume fraction of Goss grains can be explained by the boundary energy differences between grains. High energy boundaries are more likely to appear around Goss grain. Thus, to reduce the system's total energy, it is energetically favorable to consume Goss grains early in the process of grain growth. This phenomenon can also be explained by critical radius difference. In the initial step, a large number of grains smaller than critical radius are consumed. According to Equation (4), higher boundary energy also assigns a larger critical radius to Goss grain. As reported in the literature, the critical radius of Goss grains is about 9% higher than grains with other textures. Thus, more Goss grains are consumed in the initial step. Furthermore, this phenomenon can also be explained considering the pinning effect of precipitates. At the first step, according to Equations (3) and (5), the pinning force from precipitates is still high and only grains with high energy boundaries can move.

Then, in the second step, with the precipitates coarsening at longer annealing times, the pinning force is decreased according to Equation (3). In this condition, pinning provides a mobility advantage to the survived Goss grains which are larger than the critical size. As indicated in Equation (5), this mobility advantage results in faster Goss grain growth by consuming other grains which are smaller than the critical size.

Furthermore, this main texture evolution is also related to the evolution of the α*-fiber and γ-fiber texture. With the longtime annealing, fiber textures nucleated and grew into other texture orientations. Goss orientation on BCC metals have been reported to be more likely to form from the shear deformation orientation and deformed fiber textures.

For the 25% HR samples (FIGS. 15 and 16), high intensity α*-fiber and γ-fiber textures have not been observed. To the main texture volume fraction in the high C and S 25% HR sample (FIG. 19(b)), the fraction of Goss and Brass texture grains increased significantly, while the fraction of Cube texture grains decreased significantly at between 1 to 6 hrs. Then, between 6 to 24 hrs, the fraction of Goss texture grains gradually decreased as the fraction of Cube texture grains increased. For the low C and S 25% HR sample (FIG. 19(c)), the fraction of Goss texture grains gradually increased between 1 to 24 hrs, while the fraction of Cube texture grains gradually decreased between 6 to 24 hrs.

The volume fraction of Cube grains at 1 hr can be considered to be influenced by the presence of Cube grains formed before the annealing process. In some cases, Cube texture components were retained after heavy cold rolling because deformed Cube grains serve as nucleation sites for new Cube grains. For the 1 to 6 hrs high C and S sample (FIG. 11(b)) and the 1 to 24 hrs low C and S sample (FIG. 11(e)), the increase in the fraction of Goss grains can be explained by the second step, which is caused by a decrease of pinning force giving a boundary mobility advantage to large Goss grains. Finally, with a further decrease of the pinning force and an increase of Goss grains, the mobility advantage becomes similar for all grains. At this point, selective growth of the Goss grains stopped, and normal grain growth was established.

For the 47% HR samples (FIGS. 17 and 18), high intensity α*-fiber and γ-fiber textures have also not been observed. For the 47% HR sample (FIGS. 19(c) and (f)) between 1 to 6 hrs, the fraction of Goss texture grains increased, and the fraction of Cube texture grains decreased significantly. Between 6 to 24 hrs, the fraction of Goss grains decreased with the sharp increase in the fraction of Cube grains.

In this case, the reversal in the fractions of Goss and Cube grains is related high volume fraction change in the final step (6 to 24 hrs) is considered to be caused by the formation of Cube grain from rotated Goss grains. It has been reported that the crystal volumes or crystallites of Cube orientation formed from the shear band of rotated Goss orientation. It has also been reported that, with the increase of strain, the Cube orientation is the most stable orientation formed from the shear bands of rotated Goss grains.

### Model for Core Loss

Core loss is influenced both by the grain size and texture distribution. It is difficult to separate their individual contributions to core loss. A qualitative model and equation for predicting core loss would be helpful to separate the contribution of grain size and texture distribution contributions to core loss.

For grain size influence on core loss, it has been reported that the influence by grain size can be formulated as follows [21]:

$${P}_{G} = A + B {d}^{- 1} + C {d}^{- 2} \qquad ( 6 )$$

where d is the average grain size, A to C are positive constant depend on the chemical composition, precipitate size distribution, and test conditions.

According to the model, A represents the energy loss caused by eddy current and domain magnetic direction rotation in each single grain. It is influenced by chemical composition. Bd⁽⁻¹⁾ is the energy loss when the domain wall migrates inside the grain. This energy loss is influenced by grain size and precipitate size distribution. Cd⁽⁻²⁾ represents the energy loss when eddy current passes through the grain boundaries. In practice, this energy loss is very small, because it is difficult for a domain wall to pass through a grain boundary.

For the influence by the texture distribution, Goss and Cube textures provide the main benefit to the magnetic properties. We assume that this effect is linear. The equation for the texture distribution influence is:

$${P}_{T} = D {F}_{C} + E {F}_{G} \qquad ( 7 )$$

where D to E are positive constants, F_C and F_G are the percent of grains with Cube and Goss texture.

Combining Equation (6) and Equation (7), with the measured results, all the constants were determined using a MATLAB calculation. The resultant equation that relates core loss to grain size, texture distribution at 1.5 T 50 HZ for the Fe-3.4 wt. % Si non-oriented electrical steel is as follows:

$${P}_{1.5 / 50} = {P}_{G} + {P}_{T} = 3.011 + 7.604 {d}^{- 1} + 244.255 {d}^{- 2} - 0.016 {F}_{C} - 0.031 {F}_{G} \qquad ( 8 )$$

A comparison between calculated core loss value and the measured core loss (P_{1.5/50}) are shown in FIG. 20. As demonstrated in the figure, the calculated value is in reasonable agreement with the measured core loss values for a range of processing conditions. This equation separates the grain size and texture fraction's influence on core loss.

To test the model, two additional groups of samples (Table 6) with similar average grain size were selected for evaluation. In group 1, a “Low C and 25% HR (6 hrs)” sample with larger grain size and a lower percentage of Goss and Cube grains was used. As calculated using Equation (6), the “Low C and S 25% HR (6 hrs)” sample have a higher core loss, as predicted by Equation (6). In group 2, the average grain sizes of samples are similar to each other. The “High C and 25% HR (24 hrs)” sample has a higher percentage of Goss and Cube grains, and in turn has a lower calculated core loss, as predicted. The measured results are in reasonable agreement with the calculated core loss values for these samples.

TABLE 6
Grain size, texture grain fraction, and magnetic properties comparison.

| | | Measured | Average | Goss Grain | Cube Grain | Calculated |
|---|---|---|---|---|---|---|
| | | P_{1.5/50} | grain size | fraction | fraction | P_{1.5/50} |
| Group | | (W/kg) | μm | % | % | (W/kg) |
| 1 | Low C&S 0% HR (24 hrs) | 2.790 | 136 | 11.50 | 0.01 | 2.724 |
| | Low C&S 25% HR (6 hrs) | 2.808 | 147 | 9.51 | 0 | 2.779 |
| 2 | Low C&S 25% HR (6 hrs) | 2.808 | 147 | 9.51 | 0 | 2.779 |
| | High C&S 25% HR (24 hrs) | 2.380 | 148 | 17.50 | 9.40 | 2.381 |

Although Equation (8) separates the influence by grain size and texture, but it is a simple semi-empirical model. For example, anomalous losses have not been considered in the calculation, and the influence by texture fraction is assumed to be linear, which still need more theoretical study. Further research is needed to make this calculation more accurate and can be used for different silicon steel compositions and service conditions.

### CONCLUSIONS

In the above experimental work, Fe-3.4 wt. % Si non-oriented electrical steel strip samples were produced in the laboratory to simulate the solidification conditions of the thin strip twin-roll casting process. Thermo-mechanical processing routes with 0% HR, 25% HR, and 47% HR were studied on samples with high and low C and S.

The measured magnetic properties of the fully processed 25% HR and 47% HR samples all met the requirements for 35W250 NGO electrical steel in GB/T 2521.1, which is 2.50 W/kg for P_{1.5/50}.

For the samples with the same HR deformation, the low C and S samples were observed to have a coarser average grain size after final annealing. It is likely that the high C and S samples were influenced by an α to γ phase transformation occurring during recrystallization annealing and the presence of austenite during hot deformation process. With an increase of the HR deformation, the average grain size after final annealing was also increased. This coarser grain size also led to lower core loss (P_{1.5.50}, P_{1.5/60}, P_{1.0/50}, P_{1.0/60}) and higher magnetic induction (B₂₅, B₅₀).

In some cases, Goss orientation seems to have a more positive effect on decreasing core loss than grain size. For example, samples at 25% HR with low C and S and high C and S show similar core loss (1.5 T condition) results despite the fact that the grain size in the former is coarser than in the latter. For the final annealed sample with high C and S, the intensities of Goss orientation were decreased with an increase in HR deformation. This observation is considered to be influenced by the decreased proportion of shear bands.

With increasing annealing times at 1050° C. from 1 to 24 hrs, the average grain size increased, and the core loss of the fully processed samples decreased. Furthermore, the increasing annealing time also had a strong influence on the evolution of grain texture. The texture evolution in the 0% HR samples was influenced by the presence of high intensity α*-fiber and γ-fiber textures formed before the annealing process from the high percentage of cold reduction used in this processing path.

Texture evolution can be divided into several different stages. In the initial stage of annealing, the fraction of grains smaller than critical radius decreased, but Goss grains were consumed more rapidly. Then, in the second stage of annealing, the fraction of Goss grains increased by consuming other grains.

It is proposed that with the coarsening of precipitates, decreased pinning provides a mobility advantage to the surviving Goss grains which are larger than the critical size for growth. Finally, with a further decrease of pinning force and an increase of grain size, normal grain growth is established. In this step, Cube grains can form from rotated Goss grains.

A simple model of core loss was developed to explain the influence of grain size and texture distribution on core loss. By comparing two groups of results, this equation successfully separated the influence of grain size and texture distribution on core loss.

### Additional Experimental Work

The applicant has carried out additional experimental work on the following electrical steel melt: 0.0034% carbon, 1.23% manganese, 2.82% silicon, 0.0029% sulphur, 0.067% phosphorus, and 0.03% chromium.

Samples were produced by the above-described vacuum assisted fast cooling method, hot rolled with 25% and 47% reductions, cold rolled to 0.35 mm and annealed for 60 seconds at 950° C., 1000° C., and 1050° C.

The magnetic properties of the samples are in line with the results reported above.

While the principle and the mode of operation of the invention have been explained and illustrated with regard to a particular embodiment, it must be understood, however, that the invention may be practiced otherwise than as specifically explained and illustrated without departing from its spirit or scope.

1. A method of producing an electrical steel strip that includes:
casting a continuous thin electrical steel strip of less than 3 mm in thickness in a twin roll caster from an electrical steel melt with a superheat temperature of at least 30° C. above the liquidus temperature Tliquidus of the melt, the melt comprising: by weight, up to 0.015% carbon, between 1.0% and 2.0% manganese, between 2.70% and 3.80% silicon, silicon killed containing less than 0.01% aluminum, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions;
hot rolling the electrical steel strip in a hot rolling mill and reducing the thickness of the strip;
cooling the electrical steel strip in a cooling station and cooling the strip; and
coiling the electrical steel strip in a coiler and forming coils of lengths at the coiler.

2. (canceled)

3. (canceled)

4. (canceled)

5. (canceled)

6. (canceled)

7. The method defined in claim 1 wherein the electrical steel melt comprises:
by weight, up to 0.006% carbon, between 1.45% and 1.55% manganese, and between 3.35% and 3.45% silicon.

8. The method defined in claim 1 wherein the electrical steel melt comprises:
by weight, up to 0.002% S, up to 0.018% P, up to 0.03% Cr, up to 0.002% Mo, up to 0.002% Al, up to 0.03% Cu, up to 0.03% Ni, up to 0.002% Nb, up to 0.002% Ti, and up to 0.002% V.

9. The method defined in claim 1 wherein the electrical steel melt comprises:
by weight, up to 0.009% N and up to 0.002% H.

10. (canceled)

11. (canceled)

12. The method defined in claim 1 includes annealing the electrical steel strip to obtain non-grain oriented electrical steel strip with magnetic properties described in Chinese Standard GB/T 2521.1-2016 entitled “Cold-rolled electrical steel delivered in the fully-processed state-Part 1: Grain non-oriented steel strip (sheet)”.

13. The method defined in claim 12 wherein the annealing step is conducted in a controlled atmosphere comprising a mixed gas of hydrogen and nitrogen.

14. The method defined in claim 1 wherein the superheat temperature is Tliquidus+up to 120° C., i.e. up to 120° C. above the liquidus temperature.

15. The method defined in claim 1 includes controlling the hot rolling step so that there is a hot rolling mill exit temperature of 800-900° C.

16. The method defined in claim 15 includes supplying nitrogen to a hot box that encloses the electrical steel strip between the twin roll caster and the hot rolling mill at a rate of greater than 2500 m³/hr so that there is a high N concentration in the hot box.

17. The method defined in claim 1 includes controlling the hot rolling step so that there is a hot rolling mill exit temperature of 720-820° C.

18. The method defined in claim 17 includes supplying nitrogen to a hot box that encloses the electrical steel strip between the twin roll caster and the hot rolling mill at a rate of less than 2500 m³/hr so that there is a low N concentration in the hot box.

19. (canceled)

20. (canceled)

21. An apparatus for producing an electrical steel strip, including:
a twin roll strip caster for forming a continuous thin metal strip of less than 3 mm in thickness from a molten electrical steel melt with a superheat temperature of at least 30° C. above the liquidus temperature Tliquidus of the melt, the melt comprising: by weight, up to 0.015% carbon, between 1.0% and 2.0% manganese, between 2.70% and 3.80% silicon, silicon killed containing less than 0.01% aluminum, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions;
a hot rolling mill for reducing the thickness of the electrical steel strip;
a cooling station for cooling the electrical steel strip; and
a coiler for forming coils of the selected lengths of the electrical steel strip.

22. The apparatus defined in claim 21 includes a cold rolling mill to reduce the thickness of the strip in the coils.

23. The apparatus defined in claim 22 includes an annealing unit for annealing the electrical steel in the coils to obtain non-grain oriented electrical steel strip with desired magnetic properties.

24. A twin roll strip cast and hot rolled electrical steel strip of less than 3 mm in thickness having a composition of by weight, up to 0.015% carbon, between 1.0% and 2.0% manganese, between 2.70% and 3.80% silicon, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions.

25. The electrical steel strip defined in claim 24 having a microstructure that is a ferritic microstructure.

26. The electrical steel strip defined in claim 24 having a microstructure that is equiaxed grains.

27. A twin roll strip cast, hot rolled, cold rolled and annealed electrical steel strip of less than 3 mm in thickness having a composition of by weight, up to 0.015% carbon, between 1.0% and 2.0% manganese, between 2.70% and 3.80% silicon, up to 0.4% Cu; up to 0.3% Cr; up to 0.3% Ni; up to 0.2% Mo; up to 0.01% Ti; up to 0.005% Nb; up to 0.005% V, up to 0.3% Sb; up to 0.3% Sn; and the remainder iron, impurities and inclusions.

28. The electrical steel strip defined in claim 27 having a microstructure that is a ferritic microstructure.

29. The electrical steel strip defined in claim 27 having a microstructure that is equiaxed grains.
